(19) United States
(12) Patent Application Publication
(10) Pub. No.: US 2017/0116693 A1
(43) Pub. Date: Apr. 27, 2017

(54) Systems and Methods for Decentralizing Commerce and Rights Management for Digital Assets Using a Blockchain Rights Ledger

(71) Applicant: Verimatrix, Inc., San Diego, CA (US)

(72) Inventors: Christopher Rae, San Diego, CA (US); Niels J. Thorwirth, San Diego, CA (US)

(73) Assignee: Verimatrix, Inc., San Diego, CA (US)

(21) Appl. No.: 15/336,778

(22) Filed: Oct. 27, 2016

Related U.S. Application Data
(60) Provisional application No. 62/246,992, filed on Oct. 27, 2015.

(51) Int. Cl. G06Q 50/18; G06Q 20/38; G06F 21/10; G06Q 20/10; H04L 9/32; H04L 9/30

(52) U.S. Cl. CPC G06Q 50/184; H04L 9/3247; H04L 9/30; G06F 21/10; G06Q 20/10; G06Q 20/3829; G06Q 2220/00

(57) ABSTRACT

Systems and methods for decentralizing commerce and rights management for digital assets using a blockchain rights ledger in accordance with embodiments of the invention are disclosed. In one embodiment, a playback device for accessing content using a decentralized blockchain rights ledger includes a processor, a network interface, a memory connected to the processor, where the memory includes: a decentralized blockchain rights ledger, a platform identifier, a public and private key pair associated with the platform, a ledger modification application, and a playback application, the ledger modification application configures the processor to: receive a first new block created and distributed by a first blockchain management device, update the decentralized blockchain rights ledger with the first new block received from the first blockchain management device, the playback application directs the processor to: obtain an encrypted digital media work, generate a digital representation of the digital media work stored in memory, locate a platform license transaction corresponding to the identified digital representation and matching platform identification number, where the platform activation transaction identifies a platform that is permitted to play back the digital media work and contains an encrypted content key with which the digital media work can be decrypted, where the encrypted content key is encrypted with a public key of a public and private key pair associated with the identified platform, and decrypt the encrypted content key using the private key of the public and private key pair associated with the platform, and decrypt content from the digital media work using the decrypted content key and play back the decrypted content.

### CROSS-REFERENCE TO RELATED APPLICATIONS

This application claims priority under 35 U.S.C. §119(e) to U.S. Provisional Application Ser. No. 62/246,992, entitled “Decentralized Commerce & Rights Management System For Digital Assets” to Rae, et al., filed Oct. 27, 2015.

### FIELD OF THE INVENTION

The present invention generally relates to managing rights to digital assets and more specifically to a decentralized infrastructure and system including smart contracts to manage rights for digital assets utilizing blockchain rights ledgers.

### BACKGROUND

Infrastructure choices for the distribution of digital assets have significantly changed in recent years. From uni-directional networks controlled by few that had control of airwaves, cables and satellites to a general purpose, shared Internet infrastructure that allows unrestricted two-way peer-to-peer communication. From playback hardware that is dependent on a few manufactures that create playback devices for TV signals and media to general-purpose computers that allow use of software that enables media playback. From large-scale investment required to produce and publish media, to ubiquitous hardware and software to create, edit and distribute content in form such as text, video and audio. However, the issuing, maintenance and trade of resulting assets is still limited to the control of few distribution systems that manage the commerce, usage rights and control the playback infrastructure in a centralized fashion. Examples include Apple iTunes, Google Play, Netflix, BluRay, DECE UltraViolet, Disney Movies Anywhere, TV and VOD service and other content ecosystems.

### SUMMARY OF THE INVENTION

Systems and methods for decentralizing commerce and rights management for digital assets using a blockchain rights ledger in accordance with embodiments of the invention are disclosed. In one embodiment, a playback device for accessing content using a decentralized blockchain rights ledger includes a processor, a network interface, a memory connected to the processor, where the memory includes: a decentralized blockchain rights ledger, a platform identifier, a public and private key pair associated with the platform, a ledger modification application, and a playback application, the ledger modification application configures the processor to: receive a first new block created and distributed by a first blockchain management device, update the decentralized blockchain rights ledger with the first new block received from the first blockchain management device, the playback application directs the processor to: obtain an encrypted digital media work, generate a digital representation of the digital media work stored in memory, locate a platform license transaction corresponding to the identified digital representation and matching platform identification number, where the platform activation transaction identifies a platform that is permitted to play back the digital media work and contains an encrypted content key with which the digital media work can be decrypted, where the encrypted content key is encrypted with a public key of a public and private key pair associated with the identified platform, and decrypt the encrypted content key using the private key of the public and private key pair associated with the platform, and decrypt content from the digital media work using the decrypted content key and play back the decrypted content.

In a further embodiment, the playback application also directs the processor to: generate a digital representation of the digital media work stored in memory, locate a license issuance transaction corresponding to the identified digital representation and matching the digital signature associated with the user, where the license issuance transaction identifies a user that is permitted to play back the digital media work and contains an encrypted content key with which the digital media work can be decrypted, where the encrypted content key is encrypted with a user key associated with the identified user, decrypt the encrypted content key using the private key of the public and private key pair associated with the user, decrypt content from the digital media work using the decrypted content key and play back the decrypted content.

In another embodiment, the playback application also directs the processor to: generate a digital representation of the digital media work stored in memory, locate a platform license transaction corresponding to the identified digital representation and matching platform identification number, where the platform license transaction identifies a platform that is permitted to play back the digital media work and contains a first encrypted content key segment of a content key with which the digital media work can be decrypted, where the first encrypted content key segment is encrypted with a platform key associated with the identified platform, locate a license issuance transaction corresponding to the identified digital representation and matching the digital signature associated with the user, where the license issuance transaction identifies a user that is permitted to play back the digital media work and contains a second encrypted content key segment of a content key with which the digital media work can be decrypted, where the second encrypted content key segment is encrypted with a user key associated with the identified user, decrypt the first encrypted content key segment using the private key of the public and private key pair associated with the platform, decrypt the second encrypted content key segment using the private key of the public and private key pair associated with the user, and generate a combined content key based on the first and second encrypted content key segments, decrypt content from the digital media work using the combined content key and play back the decrypted content.

In a still further embodiment, The playback device also includes a licensing terms verification application stored in memory that directs the processor to: access the decentralized blockchain rights ledger stored in memory, generate a digital representation of the digital media work stored in memory, locate a license issuance transaction corresponding to the identified digital representation and matching a digital signature associated with the user, determine the license restrictions contained in the license issuance transaction, enforce the restrictions while playing back the digital media work.

In still another embodiment, the playback device license restrictions are selected from the group of playback counts, sublicensing authorization, duration use limits, and license transfer parameters.

In a yet further embodiment, the playback device also includes a licensing terms verification application stored in memory that directs the processor to: generate a digital representation of the digital media work stored in memory, locate a license issuance transaction in the rights ledger corresponding to the generated digital representation, determine the license issuance transaction identifier from the located license issuance transaction, generate a play count transaction by logging a play count transaction type identifier, the license issuance transaction identifier, the platform identifier, and a digital signature generated using the private key of the public and private key pair associated with the platform, and distribute the play count transaction to other devices participating in the decentralized rights management system.

In yet another embodiment, the playback device also includes a licensing terms verification application stored in memory that directs the processor to: generate a digital representation of the digital media work stored in memory, determine the number of play count transactions in the rights ledger corresponding to the identified digital representation, platform identification number, and digital signature corresponding to the platform, compare the number of play count transaction to a predetermined play count limit number, and configure playback conditions based on the comparison of play count transactions to the predetermined play count restriction number.

In a further embodiment again, the playback device also includes a licensing terms verification application stored in memory that directs the processor to: generate a digital representation of the digital media work stored in memory, determine a platform instance identifier, generate a platform activation transaction by logging a platform activation transaction type identifier, the digital representation of the digital media work, and the platform instance identifier.

A further embodiment includes a method for maintaining a digital rights ledger includes: accessing a decentralized blockchain rights ledger, generating a registration entry for addition to the decentralized blockchain rights ledger the registration entry is generated by logging a digital representation of a digital media work and a public key associated with a creator of the digital media work, determining whether any transactions not previously entered into the decentralized blockchain rights ledger are present in the memory, generating a new header identification to represent a new block in the blockchain, identifying a last closed block in the ledger, locate header identification of the last closed block in the blockchain ledger, generating a reference using the last closed block's header identification, grouping the registration entry, unentered transactions when they are present, new header identification, and the reference to the last closed block into a single new block for addition to the blockchain system, receiving a hash challenge utilized to close the new block, creating a hash solution satisfying the hash, and distributing the new block in the blockchain to a plurality of other nodes in the decentralized blockchain rights ledger management system.

In a further additional embodiment, a blockchain management device for maintaining a decentralized blockchain rights ledger includes: a processor, a network interface, and a memory connected to the processor, where the memory includes: a public and private key pair associated with a creator of a digital media work, and a ledger creation application, where the ledger creation application directs the processor to: access a decentralized blockchain rights ledger stored in memory, generate a registration entry for addition of a work to the blockchain rights ledger where the registration entry includes a unique digital representation of a digital media work a public key to enable control over the work by using the corresponding private key and a proof of the right to register the work, and distribute the transaction in the blockchain rights ledger to other blockchain management devices using the network interface.

In another additional embodiment, the hash solution is generated by generating a hash of the new block including a nonce where the nonce is generated by attempting a series of hash solutions until a hash solution is found that satisfies the hash challenge.

In a still yet further embodiment, generating a solution to a hash challenge is accomplished through a proof of stake system.

In still yet another embodiment, the blockchain management device memory also includes a ledger modification application where the ledger modification application directs the processor to: access the decentralized blockchain rights ledger stored in memory to register a new license to a digital media work that is represented by a registration entry in the blockchain system, and generate a license issuance transaction by logging the digital registration of the digital media work along with the terms of the license, a transaction type identifier, the public key of the public and private key pair associated with the creator of the digital media work, and a public key of a public and private key pair associated with the licensee of the digital media work.

In a still further embodiment again, the blockchain management device ledger modification application also directs the processor to digitally sign the license issuance transaction with the private key of the public and private key pair associated with the licensor and with the private key of the public and private key pair associated with the licensee.

In still another embodiment again, the blockchain management device ledger modification application also directs the processor to encrypt at least a portion of a content key using the public key of the public and private key pair associated with the licensee, where the content key can be used to decrypt an encrypted copy of the digital media work.

In a still further additional embodiment, the blockchain management device terms of the license are selected from the group of playback counts, sublicensing authorization, duration use limits, expiration dates, and license transfer parameters.

In still another additional embodiment, the blockchain management device memory also includes a ledger modification application where the ledger modification application directs the processor to: access the decentralized blockchain rights ledger stored in memory to transfer an existing license, which is represented by a license issuance transaction, to a digital media work that is represented by a digital registration in the decentralized blockchain rights ledger, generate a license transfer transaction by logging the digital registration of the digital media work to transfer along with a transaction type identifier, the public key of a public and private key pair associated with the licensor of the digital media work, and a public key of a public and private key pair associated with the licensee of the digital media work.

In a yet further embodiment again, the blockchain management device memory also includes a ledger modification application where the ledger modification application directs the processor to: generate a platform license transaction that includes a platform identifier, identification of a digital media work, and a signature generated using the private key of a public and private key pair associated with the creator of the digital media work.

In yet another embodiment again, the playback device ledger modification application also configures the processor to: receive a second new block created and distributed by a second blockchain management device, update the decentralized blockchain rights ledger with the second new block received from the second blockchain management device.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

### BRIEF DESCRIPTION OF THE DRAWINGS

FIG. 1 is a network diagram of a decentralized commerce and rights management system for digital assets in accordance with an embodiment of the invention.

FIG. 2 conceptually illustrates a blockchain management device in accordance with an embodiment of the invention.

FIG. 3 conceptually illustrates a playback device in accordance with an embodiment of the invention.

FIG. 4 conceptually illustrates blocks in a blockchain rights ledger in accordance with an embodiment of the invention.

FIG. 5 is a chart, listing various types of transactions that may be entered into a block in a blockchain rights ledger in accordance with embodiments of the invention.

FIG. 6 is a flow chart illustrating a process for creating a blockchain rights ledger for commerce and rights management of digital assets in accordance with an embodiment of the invention.

FIG. 7 is a flow chart illustrating a process for creating a new ledger block for commerce and rights management of digital assets in accordance with an embodiment of the invention.

FIG. 8 is a flow chart illustrating a process for playing back content using a blockchain rights ledger in accordance with embodiments of the invention.

### DETAILED DESCRIPTION OF THE DRAWINGS

Turning now to the drawings, systems and methods for a decentralized infrastructure and system to manage rights for digital assets in accordance with various embodiments of the invention are illustrated. As discussed above, many conventional digital content ecosystems are governed by centralized entities. The centralization can be problematic since this market rewards monopolistic size in which one entity amasses power by controlling end-to-end access to consumers and content and consumers are locked into control of their purchased content by that entity, risking that they are no longer able to play content (i.e. digital asset) and prove ownership, if this entity does no longer supports the delivery of content or stops providing decryption keys. In addition, there may be a transaction cost for the content distribution and limited ability to influence the content protection requirements for each piece of content by its creator.

Many embodiments of the present invention include a decentralized, distributed digital rights ledger that documents the rights transfer (also called licenses) from creators to end-users (also called licensees, users, end users or consumers) and/or between end users, referred to here as a blockchain rights ledger. In many embodiments, the rights ledger is stored, modified and maintained on several independent nodes and trust is established by rules on the format on the ledger rather than the source and origin of the information. In such embodiments, the rules are established with cryptographic principles that make modification of the data difficult. In further embodiments, no centralized third party of trust is needed for transactions involving license distribution, selling, data-tracking, metrics analytics, and/or auditing. In many embodiments, content creators (or copyright owners) are motivated to verify and confirm past licenses, document and log transactions, and solve challenges which provides the right to register a new creation (also called work, asset or content) in the blockchain rights ledger in return. In certain embodiments, creations include, but are not limited to, text, images, audio, and video, but can also include any licensable work that can be represented in digital form. A copy of a creation may be referred to as a piece of content. In many embodiments, a blockchain rights ledger having a record of a creation evidences that a creator created a media work and additional transactions in the blockchain rights ledger can provide a right for a user account or playback device to access and/or play back a piece of content that is a representation of that creation.

In a number of embodiments, the blockchain rights ledger is stored and verified in a decentralized fashion, i.e. replicated to different entities (that may be referred to as nodes) that are separately able to verify past transactions. In further embodiments, the ownership of a creation as well as license rights can be proven using cryptographic principles. In many embodiments, the chaining of transactions, cryptographic verification and the hash challenge utilizes a block chain system based on principles and/or mechanisms similar to those in the art of cryptocurrency. Techniques for managing blockchains in the context of currency are described in “Bitcoin: A Peer-to-Peer Electronic Cash System” by Satoshi Nakamoto, published in 2008, the disclosure of which relevant to blockchain management is hereby incorporated by reference in its entirety.

A block chain can typically be understood to be a distributed database that maintains a continuously-growing list of records called blocks. Each block contains a link to a previous block generated using a hash of the previous block, and often includes mechanisms for protection from tampering and revision. The block chain is distributed so that copies are replicated among participating nodes in the system. As transactions are added the copies are extended and the longest chains are trusted that follows a rule and provide according proof of work or stake. Nodes may be any of a variety of hardware devices or playback devices, such as, but not limited to, servers, workstations, desktop computers, mobile devices, and/or tablets, configured to participate in the decentralized digital rights system as discussed further below. More specifically, nodes can include blockchain management devices and playback devices as described in greater detail further below.

In some embodiments, pieces of content are interpreted and used with a platform (which can be a playback device, viewer, app, application, client or decoder as will be discussed further below) that can play back many forms of media using a player application. In certain embodiments, identifying the platform can be an important tool to limit piracy of assets by using encryption and/or other mechanisms that can limit creations to specific platforms. The creator of the work can authorize (e.g., by cryptographically linking) specific platforms to a creation by registering it in the blockchain rights ledger. In many more embodiments, the blockchain rights ledger may be utilized to enable a platform to verify and enforce limitations or usage rules imposed on the content by the license such as (but not limited to): limiting the number of playbacks, limiting the transfer of the license, and limiting the length of time allowed for a playback to occur. Techniques for managing access to digital content are disclosed in U.S. Patent Publication No. 2013/0060616 entitled “Managing Access to Digital Content Items” to Block et al., filed Jun. 22, 2012, the disclosure of which relevant to managing access to digital content is hereby incorporated by reference in its entirety.

Usage rules may be determined by the creator by issuing usage rules and/or limiting approved platforms. In yet additional embodiments, licensing and other transactions can be accompanied with financial transactions for purchase on another platform, including cash, credit card, Bitcoin or any of a variety of other forms of electronic payment system. The financial transactions can be independent of the registration and execution of the rights ledger. Alternatively bitcoin transactions can be referenced from the rights ledger or smart contracts can bind payment and rights licensing. Systems and methods for performing quality based streaming of content in accordance with various embodiments of the invention are discussed further below.

### Decentralized Digital Rights Ledger Systems

A decentralized digital rights ledger system can allow creators to increase control of their content, reduce transaction costs and friction, i.e., the ability to get to market faster and with less cost. This can be accomplished by removing the need for middlemen distributors, subscriber management systems, centralized and proprietary rights management systems, network infrastructure, etc. A decentralized digital rights ledger system for rights management can increase revenue and payment security for content owners across a fragmented pool of operators and solutions. The decentralized digital rights ledger system can allow for a “publish-once” methodology, eliminating the need for walled gardens of content and payment solutions. The ledger system can also help establish intellectual property rights by creating an exact and virtually immutable record that can show a work's registration date and rightful owner. Additionally, due to the fact that the smart contracts in the ledger do not need to be limited by legal and geographical boarders the ledger allows content creators to license works globally and the system can be used where there may not be a proper payment system or trusted agent to facilitate a standard licensing transaction. Due to the static and public nature of a ledger block chain, creators can easily calculate proper royalty payments, as well as track additional marketing data.

In many embodiments, the system has a further benefit of being pseudonymous, i.e., the content transaction cannot be traced to an individual or location but a pseudonym (key) and are therefore protecting consumer's privacy.

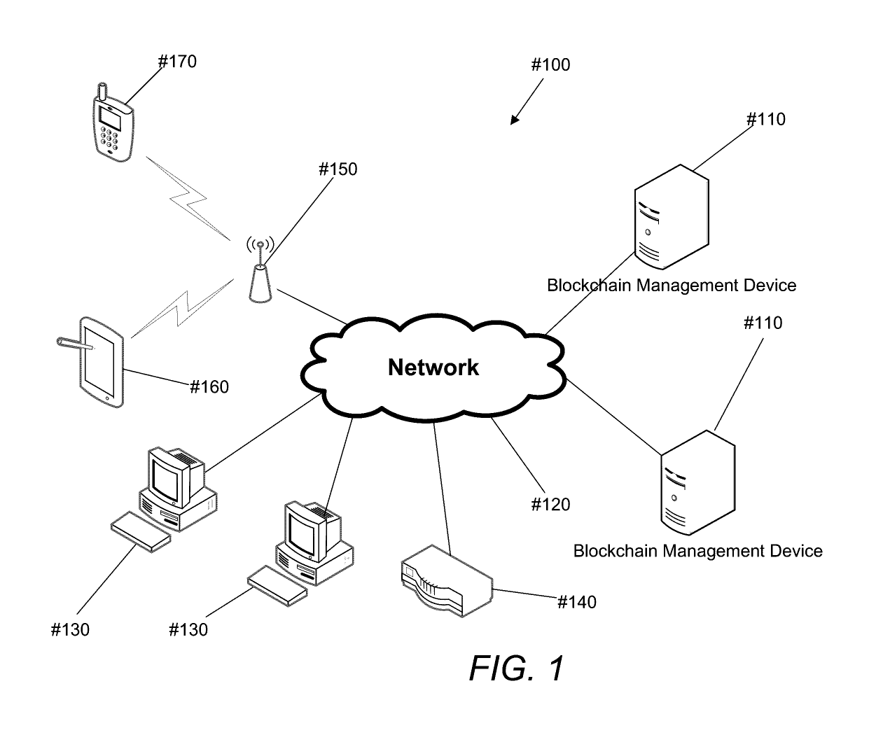

A decentralized digital rights ledger system in accordance with an embodiment of the invention is illustrated in FIG. 1. The digital rights ledger system 100, includes a blockchain management device 110 that can communicate with one or more other nodes via a network 120. Additionally, the digital rights ledger system 100 includes a variety of playback devices that may run on hardware such as personal computers 130, set-top boxes 140, mobile phones 170, personal computing devices 160, some of which may communicate on the network 120 via a wireless access point 150.

The digital rights ledger system 100 includes a blockchain management device 110 configured to create an initial genesis block in a ledger file. This new ledger file may be transmitted over the network 120 to other nodes including playback devices 130, 140, 160, 170 and other blockchain management devices 110. In many embodiments, the digital rights ledger system 100 is decentralized in that entire copies of a particular ledger file are stored on multiple nodes. In other embodiments, some copies may be a pruned copy of the ledger file. Participating nodes may utilize a copy of the ledger and make the transaction history available for download to others per default via network 120 such as by utilizing peer-to-peer protocols.

Content creations that have been registered and licensed in the ledger may be distributed to playback devices for immediate or later playback. Certain playback attributes and other license restrictions may be stored in a playback device's local memory. In additional embodiments, certain license restrictions like playback count and license expiration may be utilized by the playback device to limit playback without having to be updated in the ledger.

For decentralized currencies the aim often is to limit minting of new coins over time, in order to control the number of coins getting into circulation per interval to limit inflation. To control the interval, the challenge to solve is adjusted to the applied processing power, i.e. increase of difficulty as a reaction to a quicker solution. The digital rights ledger system 100 typically is not limited in this way as inflation is not a concern. Instead, a more active system with more users and miners can create more rights issued per time. Hash challenge difficulty would likely not have to vary much except for possible increases to maintain security due to increased computing power. In this sense, the control of inflation can be different from a currency system because the issuing of a number of additional different works does not typically devalue other creations that have already been registered, unlike with currency.

In several embodiments, the right or ability to register a media work into the blockchain rights ledger is represented by a work registration token that is earned by finding solutions to a hash challenge (e.g., the hash challenge required to close a block). Each solution may reward the solver with work registration tokens, where the number of tokens (RN) granted per solution is configurable as an aspect of regulating the rate at which works can be registered into the blockchain rights ledger. The reward can be a single token, fraction thereof, or multiple.

For example, if the frequency at which solutions are being found should be decreased, the number of tokens RN granted can be increased allowing more works to be registered with less work, resulting in less mining and a lower frequency. If the frequency at which solutions are being found should be increased, the number of tokens RN granted can be decreased.

Similar to the hash challenge in bitcoin the adjustment can be automated by changing it in accordance with a targeted frequency of closing a block. A higher frequency will have more overhead but is quicker to secure the transactions, which is important to verify a license transfer for immediate consumption or playcount validation. It can also depend on the length of a typical asset where the verification of a feature film with 15 minutes may be acceptable.

In several embodiments, this can be an alternative to adjusting the difficulty of the hash challenge itself. A work registration token may be represented as a unique value and associated with a private key holder by publishing the public key. One token grants the ability to register one work into the blockchain rights ledger. Fractional tokens can be combined and a combination of token quantities resulting in more than one result in a residual token quantity that can be used to issue other rights. This is similar to combining bitcoin transaction values to match a desired transaction value.

In a number of embodiments, parallel ledger systems may exist and either work together or be indexed alongside each other. The licensed creations may not be interchangeable and devices could look into several different databases for works based on a number of filters including, but not limited to, creations from similar regions, different content owners, and/or creation times. The decentralized ledger may work with external web services or individual clients to provide information about the ledger including, but not limited to, creation contents, recommendations, ratings, and discovery.

Where discussions herein may refer to an owner, creator, or user performing certain actions with respect to a digital rights ledger or processes involving digital rights ledgers, one skilled in the art will recognize that such actions may be performed by and through a device such as a workstation, desktop computer, mobile device, laptop, tablet, and/or playback devices such as those discussed above. Various devices that participate in a decentralized digital rights ledger system may be referred to as nodes. Further, these actions may be conducted in processes such as those discussed further below and implemented by processors configured by applications stored in memory to perform all or part of those processes. While a variety of decentralized digital rights ledger systems are described above with reference to FIG. 1, the specific components utilized within a decentralized ledger system and the manner in which ledgers are stored and maintained may vary in accordance with the requirements of specific applications. Blockchain management device systems that can be utilized in decentralized digital rights ledger systems in accordance with various embodiments of the invention are discussed further below.

### Blockchain Management Devices

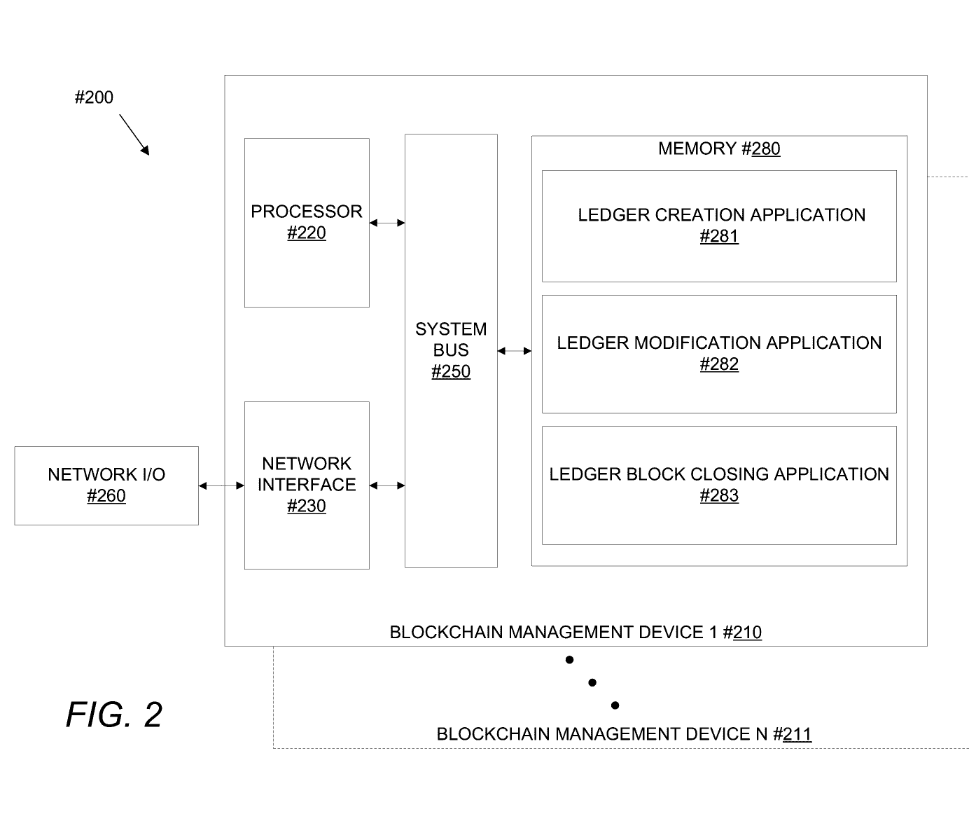

A blockchain management device that can be used to create and/or modify a digital rights ledger in accordance with embodiments of the invention is illustrated in FIG. 2. The blockchain management device 210 includes a processor 220, network interface 230, network input/output 260, system bus 250, and memory 280. Memory 280 includes a ledger creation application 281, ledger modification application 282, and ledger block closing application 283. Ledger creation application 281 can configure processor 220 to perform processes to generate a digital rights ledger such as those discussed further below. Ledger modification application 282 can configure processor 220 to perform processes to modify a digital rights ledger such as those discussed further below to add blocks to the ledger. Ledger block closing application 283 can configure processor 220 to perform processes to close a digital rights ledger such as those discussed further below. Blocks and blockchains may be received from and/or distributed to other block chain management devices and/or playback devices using network 120.

A decentralized digital rights ledger system may include additional blockchain management devices 211 with components similar to blockchain management device 210. While a specific architecture of a blockchain management device is discussed above with respect to FIG. 2, blockchain management devices in accordance with embodiments of the invention may utilize any of a variety of architectures as appropriate to the particular application. Content playback devices that may utilize a digital rights ledger in accordance with embodiments of the invention are discussed above.

Playback Devices that Can Utilizing a Blockchain Rights Ledger

A playback device is a platform that can be used to enforce restrictions mandated by the creator of a piece of content (a media work) and encoded in the blockchain and play the content in accordance with the restrictions. In addition, granting the playback device the ability to play back a particular piece of content by a creator can include a requirement and determination that this playback device or category of playback device is capable of playback of the piece of content. It can also represent a public promise that this platform and piece of content can be combined, given the proper license.

Playback devices may be used to display and consume different media types, including, but not limited to: audio (Stereo, Multi-channel Surround), video (2-Dimensional, 3-Dimensional) Augmented Reality (AR), and/or Virtual Reality (VR), text, images, metadata, and applications, but may also be extended to digital titles that certify ownership in other things, such as real estate properties, art and intellectual property. The manifestation of the right can be converted into a digital asset, e.g., such as by being scanned and digitally signed that is used as the digital assets the license is assigned to.

A platform may be a software playback application or a hardware device incorporating a software playback application. In a number of embodiments a platform is identified by a hash performed over the executable code of the software program that facilitates playback and/or ledger modification. In other embodiments, other characteristics of a software application or hardware device and/or information stored on a hardware device can be utilized to generate an identifier or hash of the platform. Playback of a piece of content may be enabled by a key that entitles a specific software version, or by a generalized platform key that enables only a group of device versions. In this case the creator trusts another entity (such as a company developing a software media player) to conform to requirements. This trust may be established with legal agreements, standards (that prescribe robustness rules as described above) and/or from reputation. In several embodiments of the invention the platform license cannot be revoked, in order to guarantee an immutable connection with the platform that a licensee can exercise and to foster trust by the consumer that the ability to use the content is long lasting. However, in further embodiments, if the security of the platform becomes compromised however, future assets may impose different requirements.

In still further embodiments, the platform may enforce license terms that are not registered in the ledger and agreed on with the platform or creator. However, they don't need to be standardized for all participants in the system, although a de-facto standard is helpful to foster adoption. In still further embodiments, certain license terms may not necessarily be registered in the ledger but are part of the player limitations. For example, enabling HDCP during playback or using a secure video path including a trusted execution environment can be restrictions inherent to the player.

In further still embodiments, a pruned block chain ledger is stored on the playback device instead of the entire chain of blocks referencing all the way back to the genesis block. The use of pruned blockchains allows for fast loading and processing times, especially during a verification step that examines the trail of ownership of a creation from the first registration until the current potential transaction. A blockchain can be pruned by removing transactions that are no longer relevant and/or required, such as play count transactions (excluding the most recent), license transfer transactions (excluding the most recent), and/or expired licenses. If removing transactions changes a block's hash solution, any link to that block may need to be regenerated.

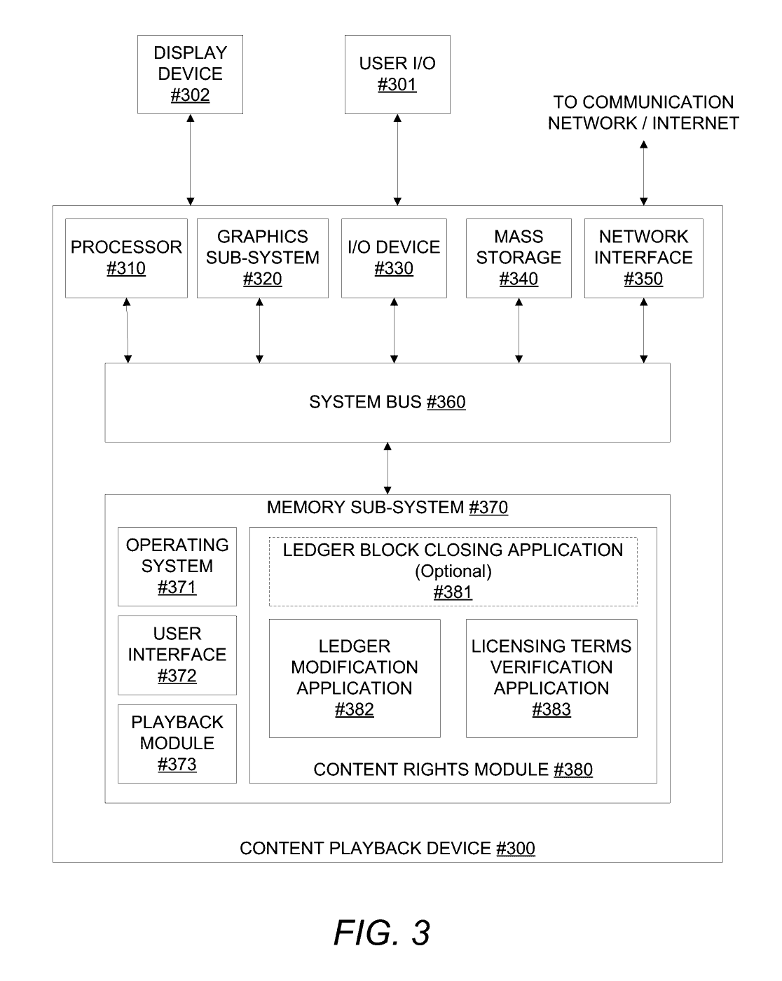

A playback device that can utilize decentralized ledger systems in accordance with an embodiment of the invention is illustrated in FIG. 3. The playback device 300 includes a processor 310, graphics sub-system 320, input/output (I/O) device 330, mass storage 340, network interface 350, system bus 360, and memory sub-system 370. The memory subsystem contains an operating system 371, user interface 372, and playback module 380. Many embodiments of the invention include a playback device 300 which has a content rights module 380 that further includes a licensing terms verification application 383 which can utilize a ledger to extract terms of a license that may be stored locally for later use. In addition, content rights module 380 can contain a ledger modification application 382 that can add new data/transactions to the ledger, as well as an optional ledger block closing application 381 that configures the processor to perform the computational work to close a block in the ledger. The applications can configure the processor to perform processes such as those discussed further below in extracting a license from a digital rights ledger and/or modifying a ledger. Certain embodiments of the invention may have a playback device 300 that utilizes the decentralized ledger system via an interface with a communication network including, but not limited to, the Internet. Additionally, further embodiments of the invention can include a display device 302 connected to the playback device 300. Still further embodiments of the invention can include user I/O (input/output) 301 to provide a user interface for interacting with playback device 300.

While a variety of playback device systems are described above with reference to FIG. 3, other playback devices incorporating any of a variety of architectures and/or hardware enabling the utilization of a decentralized digital rights ledger system in accordance with various embodiments of the invention. For example, in certain embodiments, a copy of the ledger may be stored locally in the playback device 300 and utilized when the playback device has no connection to other nodes in the ledger system. These periods are typically limited to enforce connection to the latest updated ledger.

In many embodiments, a distributed network of blockchain management devices and playback devices process and synchronize the block chain by consensus across multiple POPs (points of presence) across geographic regions or globally. The devices may respond to queries from other devices in the network in a peer-to-peer nature to validate entitlement rights of users, devices and/or content. In further embodiments, operators of blockchain management devices may be paid or offered credit towards various services, monetarily through a universal currency, or other incentives that could be used for rewards such as, but not limited to, purchasing of content from the content owners associated with this network. Payment may be conducted using the device or a secondary mechanism, such as through a payment service like Paypal or Bitcoin. In many embodiments, the processing or mining of block chain solutions done by a blockchain management device yields the right to register and license a creation instead of a direct monetary reward.

### Blockchain Rights Ledger Structure

The fundamental structure of a decentralized blockchain rights ledger includes blocks which are linked together to form a blockchain. Each block in the blockchain contains a reference to the previous block in the chain, with the exception of the genesis block which is the first block created and contains no reference. Ledger blocks contain similar components but may vary in size due to the amount of transactions that are recorded within each block. In a number of environments, the block size can exceed one megabyte.

In additional embodiments, assets in a block chain are represented by a hash (sometimes referred to as a cryptographic hash), or output of another data operation that is difficult to reverse to recover the input even when the output is known, and would be virtually unique to each creation being registered. The use of a database listing meta data of creations with their respective hashes can aide in the search for creations in the block chain. In certain embodiments, this database is stored within the block chain itself. In certain other embodiments, the database is stored externally from the block chain and referenced by methods including, but not limited to, links to other blocks in different block chains, hard drive sector locations, and/or URL addresses.

In still further embodiments, meta data relating to the registered creation can be identified in the registration itself such as, but not limited to, cover art for movies, artist information for music, URL links to download the content, and/or methods that allow for the unlocking of potential future content.

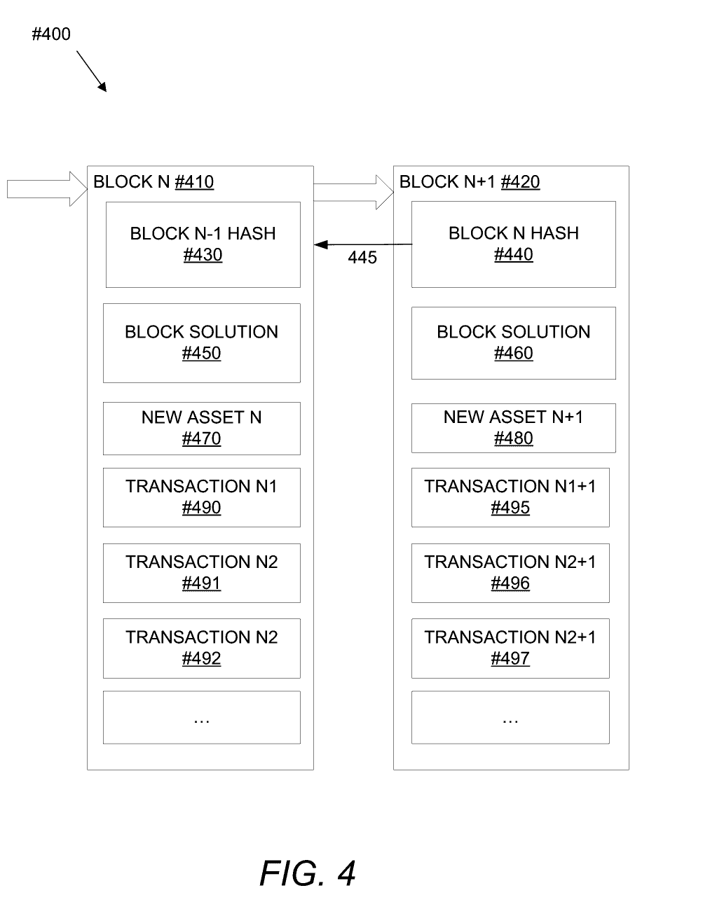

A conceptual illustration of a ledger block chain file structure in accordance with embodiments of the invention is illustrated in FIG. 4. In many embodiments, the ledger block chain segment 400 contains a first block N 410 and a subsequent block N+1 420. In a number of embodiments, each block contains a hash of the previous block in the chain. The block N hash 430 contains a hash depending on the previous block N−1 in the ledger block chain 400, while the block N+1 hash 440 also depends on the previous block N in the ledger block chain 400. Block N also contains a block N hash solution 450 which is a calculated solution to a cryptographic challenge. Each completed block requires a solution, including block N+1 420 which contains a block N+1 hash solution 460 and is not yet linked to a newer block in the current ledger block chain 400. Techniques for managing blockchains in the context of currency are described in “Bitcoin: A Peer-to-Peer Electronic Cash System” by Satoshi Nakamoto, published in 2008, the disclosure of which relevant to blockchain structure is hereby incorporated by reference in its entirety.

In many embodiments, a new creation may be registered into a block in the ledger by a device, allowing for licensing of that creation. In block N 410, new asset N 470 is entered in. In many embodiments of the invention, each new asset entry is unique to a specific creation so that new asset N 470 and new asset N+1 480 reference different works. Block N 410 also includes a group of transactions, transaction N1 490, transaction N2 491, and transaction N3 493. Likewise, block N+1 420 has a separate group of transactions N1+1 495, transaction N2+1 496, and transaction N3+1 497. In further embodiments, these transactions are discrete and not necessarily coupled with the new asset being registered or with each other.

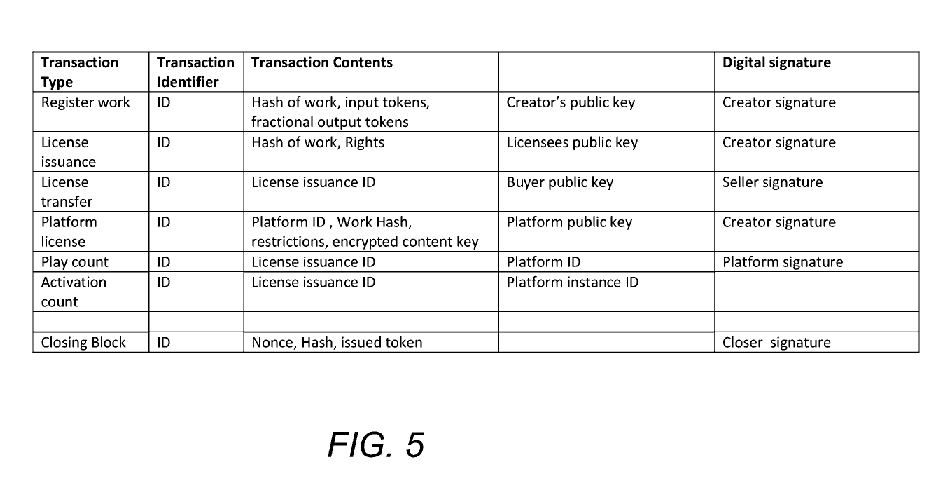

Transactions represent various types of restrictions and operations concerning a media work and can be stored in a block as entries, each having a transaction identifier (ID). As will be discussed further below, one or more transactions may be grouped for entry into a block before the block is closed. Where a description below indicates that a user or creator enters a transaction, the transaction may be entered by a device or node in the decentralized digital rights system controlled by that user or creator. A transaction may be digitally signed using a private key over all or a portion of the contents of the transaction. A chart listing various types of transactions that may be entered into a block in a blockchain rights ledger in accordance with embodiments of the invention is shown in FIG. 5.

A license issuance transaction can be entered by a creator of a work and specifies any of a variety of restrictions such as, but not limited to, a play count (number of times a user and/or platform can play the content, may include time of playback as well), a transfer count (number of times the license may be transferred to another user/licensee), transfer delay (minimum time between last play of previous licensee and first play of next licensee), and/or expiration (date after which the license is no longer valid). In further embodiments, a reference to an external license is included in place of or in addition to restrictions listed within the transaction. A license issuance transaction contains a license identifier (or transaction identifier of the license issuance transaction) of the associated license and an identification of the work, which may be a hash and may be the same as that identifying hash embedded in the registration of the work within the blockchain. In many embodiments, a license issuance transaction contains the licensee's public key to enable licensee to prove ownership. It is signed by including a signature(s) generated using the private key of the creator to show her consent.

In additional embodiments of the invention, playback of encrypted content is facilitated by including at least part of the content key that can be used to decrypt the content. The content key can be encrypted using a public key associated with a user or licensee and stored in the license issuance transaction. A user can then utilize their private key to decrypt the encrypted content key and decrypt the content.

A transaction to register a work contains a secure identification of the work such as a hash, the creator's public key to enable proof of ownership and operations like sublicensing using a private key. The work is registered in order to be used for licensing in the ledger. The right to register a work can be earned by mining in either integer or fractional increments. The right may be issued and stored via work registration tokens that are created when a block is closed (mined) and can be used to register a work.

A license transfer transaction can be entered by a initial licensee (e.g., seller) that gives her license to another licensee (e.g., buyer). A license transfer transaction contains a license identifier (or transaction identifier of the license issuance or transfer transaction) of the associated license and an identification of the buyer. In many embodiments, the identification of the buyer is her public key. In other embodiments, the licensor and licensee may be identified in other ways appreciable by one skilled in the art. Similar to the license issuance transaction described above, an encrypted content key or parts thereof encrypted using a licensee's public key can be included in the license transfer transaction The transaction is confirmed by seller with a digital signature.

A platform license transaction enables playback of the content on a specified platform by a creator. A platform license transaction includes an identification of the platform (secure platform identifier such as a hashcode) and an identification of the media work. In several embodiments, the identification of the media work is the hash of the work that is stored in the blockchain when the work is registered into the blockchain. In further embodiments, a platform license transaction includes license terms by referencing a license issuance transaction. In many embodiments, a platform license transaction includes a public key associated with a platform to enable authentication and a signature generated using the private key of the creator. In some embodiments, a product identifier can be used as a platform identifier. Product identifiers that can be used to identify products in accordance with embodiments of the invention are disclosed in U.S. Patent Publication No. 2013/0006869 entitled “Method to Identify Consumer Electronics Products” to Grab et al. and U.S. Patent Publication No. 2013/0007443 entitled “Systems and Method for Identifying Consumer Electronic Products based on a Product Identifier” to Grab et al., the disclosure of which relevant to using a product identifier to identify a product is hereby incorporated by reference in its entirety.

In additional embodiments of the invention, playback of encrypted content is facilitated by including, within a platform license transaction, a content key that can be used to decrypt the content. The content key can be encrypted using a public key associated with a class of platform or platform and stored in the platform license transaction. An enabled platform can then utilize its private key to decrypt the encrypted content key and decrypt the content. In further embodiments, enforcement can require both a user key and a platform key by splitting the content key into two or more parts and securing each part using a different key. For instance, a first part can be encrypted using a user's public key and a second part can be encrypted using a platform's public key. Both user and platform keys will then be needed to decrypt the parts of the content key so the content key can be used to decrypt the content.

A play count transaction is entered by a platform that plays back the content and represents that the platform has played or begun playback of the content. A play count transaction includes a license identifier (or transaction identifier of the license issuance transaction) of the associated license and an identification of the platform. In some embodiments, a play count transaction can increment or the total transactions can be summed to compare to license terms. In other embodiments, a first play count transaction includes the total number of allowed playbacks, and subsequent transactions decrement to represent the number of remaining playbacks allowed. The identification of the platform can include a platform identifier (ID) and/or a signature using the platform's private key.

A platform activation transaction is entered by a particular platform when it registers to play the content or begins playback of the content for the first time. Platform activation transactions can be used to track the number of individual platforms that have accessed the content and a comparison can be made to a platform count restriction in a license to determine if the number of platforms that have been given access has reached a limit. A platform activation transaction includes a license identifier that identifies the associated license and a platform instance identifier that is unique to that individual platform instance.

Although specific representations of ledger block structures are described above with reference to FIGS. 4 and 5, any of a variety of structures can be implemented using available data structures or hardware equivalents as appropriate to the requirements of specific applications in accordance with various embodiments of the invention.

The structure of the ledger block begins with creating the first block, containing a licensable work, derived without mining. The block is referred to as a genesis block, in the ledger block chain. A process that may be utilized to generate a digital rights ledger in accordance with embodiments of the invention is described below.

Many other transaction can be derived, given the above examples, including sublicensing, grouping of transactions, transfer of issuing tokens.

### Ledger Creation Process

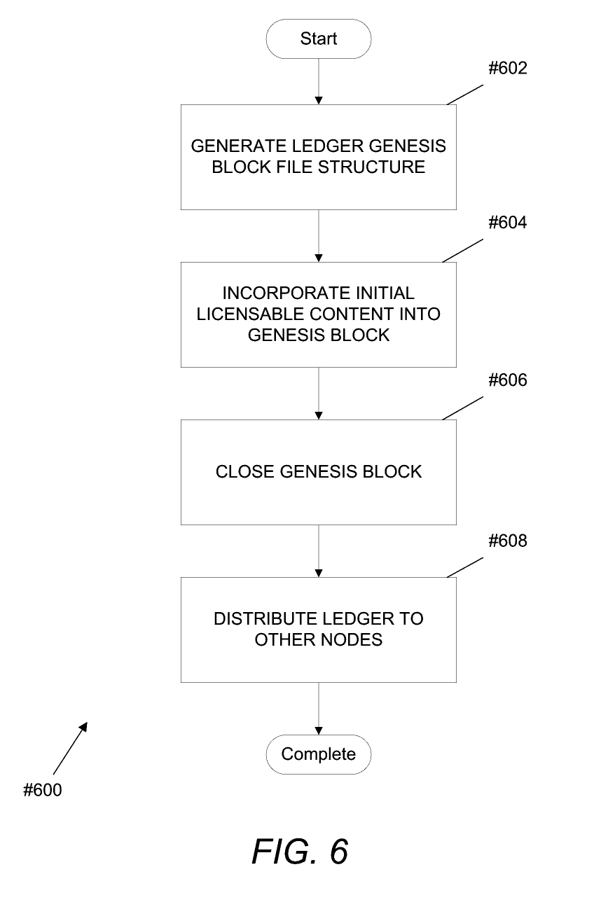

A process for creating a decentralized ledger system in accordance with an embodiment of the invention is shown in FIG. 6. In certain embodiments, the process may be performed by a blockchain management device or other node configured by a ledger creation application. The process 600 may include generating (602) a ledger genesis block file structure in which the rest of the block data will be stored. A genesis block is unique from all other blocks in a block chain as it is the only block to not point to a previous block in the chain. A new creation is incorporated (604) into the genesis block to allow for licensing of that creation. As discussed above, the creation may be represented in digital form, such as a media (e.g., image, video, audio) file(s) and incorporation into the genesis block can include taking a hash of the media file(s). In some embodiments, the genesis block may also include transactions such as licenses and/or platform restrictions. To complete the genesis block, the genesis block is closed (606) just like any other block. This closing can come in the form of a proof of work or proof of stake. A closed block is then distributed (608) to other nodes in the network.

Although specific processes for creating digital rights ledgers are described above with reference to FIG. 6, any of a variety of processes can be implemented using available blockchain management devices and/or playback devices as appropriate to the requirements of the specific applications in accordance with various embodiments of the invention. Techniques for managing blockchains are described in “Bitcoin: A Peer-to-Peer Electronic Cash System” by Satoshi Nakamoto, published in 2008, the disclosure of which relevant to blockchain management is hereby incorporated by reference in its entirety. Once created, additional new blocks can be formed in order to create a block chain from the genesis block. A process for creating new blocks in a block chain in a digital rights ledger in accordance with embodiments of the invention is discussed below.

### Processes for Creating New Ledger Blocks in a Digital Rights Ledger

When a previous block in a block chain is closed, the registration of a new asset typically starts a new block in the blockchain. This is done either directly or via issuing of work registration tokens. Tokens are required to then create a transaction for the creation of a work. A new creation is converted to digital format if required and, to manage its size while allowing proof of its existence, a hash code is derived. The hash code is signed by the creator to assign and later prove ownership of the registered work. In several embodiments, the public key is also published in the ledger for ease of application for verification. This proof that is established during registering of a work is used to issue licenses or enable platforms. In many embodiments, multiple ledgers may work together to facilitate different aspects of a licensing transaction. For example, in certain embodiments, a ledger entry may reference a cryptocurrency ledger to verify a license was paid for before issuing a new transaction.

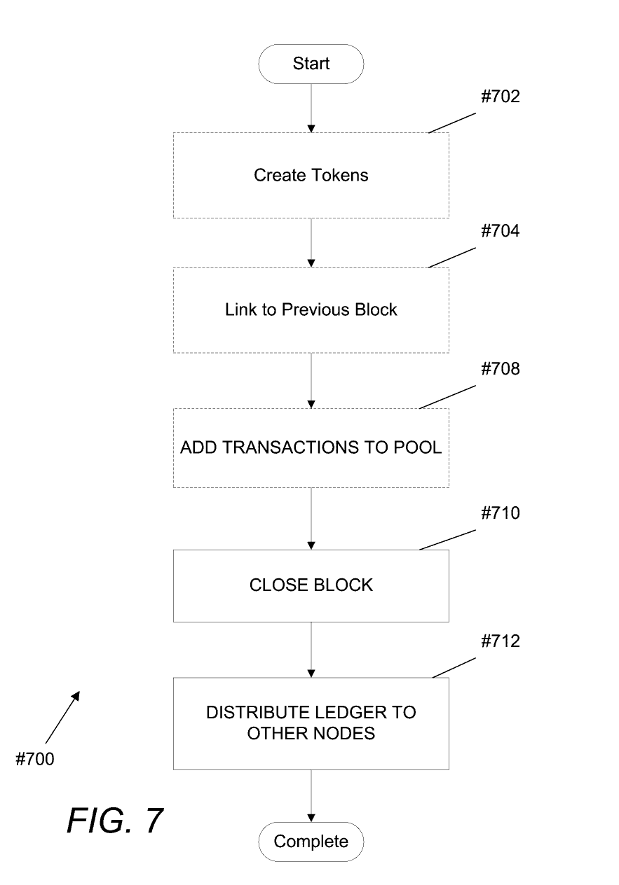

A process for creating a new block in the ledger in accordance with an embodiment of the invention is shown in FIG. 7. In certain embodiments, the process 700 may be performed by a node within a decentralized digital rights ledger system configured by a ledger creation application or ledger modification application. The block starts with the granting of the right to issue a work, which can be via the creation of work registration tokens that can later be used to register a work (702). A link is created (704) to the previous block in the blockchain rights ledger.

Transactions that are transmitted and distributed in the network are added to the block (708). Many potential actions may be represented as a transaction that can be recorded in the ledger as described further above. Some of these transactions include, but are not limited to, issuing of a license, sub-licensing or a creation, and/or platform enablement, playcount, verification of ownership of a license. Many embodiments include registering a media work into the blockchain as a transaction. In further embodiments, the creator signs a transaction that identifies the asset issued by this creator, the playback device, external license, and/or license conditions and makes this public in the ledger. In several embodiments, the signing key is the same key as used for the creation of the asset or others enabled by that key to allow sub-licensing. Sublicensing enables another public key to issue licenses. The issuance is then public and can be tracked and billed, additional sublicense restrictions could be included in or referenced by the ledger in order to limit the amount and frequency with smart contracts that match agreements between the creator and licensee. Sublicenses could be video distribution operators, including cable, IPTV, satellite and internet platforms that manage, distribute a stream of digital assets, including entertainment content. The signing ensures cryptographically that the creator is the only one issuing granting direct rights to the work or enabling others. In several embodiments, the public key matching the private signing key is also securely published in the ledger.

Another potential type of transaction is a transfer which occurs when one licensee transfers their license to another person using the decentralized ledger. In many embodiments, implementation of different licensing models are available including, but not limited to: sale, rental, pay-per-view, and/or re-sale of individual licenses for second-hand markets. In a number of embodiments, there are limits placed on the amount of transactions allowed which may simulate a more marketplace style of environment.

In yet further embodiments, a platform key is created and utilized to bind a license to a platform or group of platforms, e.g., categories, classes, or models of playback devices or player software applications on playback devices. This can be enabled by encrypting the content decryption key also with a public key of a platform. To keep the number of licenses small (avoiding issue of a license for all platforms), several platforms can share one public-private key pair or keys can be grouped in external files and managed similar to other external license systems. In yet still further embodiments, platforms may manage different keys for all assets so that one asset breach does not compromise other assets on the platform. In additional embodiments, the platform keys may also be released after the license is issued, allowing for pre-sales of the license and distribution of the asset while keeping the asset decryption key secured for the release date. Maintaining keys in grouped files also allows for updates that enable adding platforms to the pool later. To guarantee that platforms are not removed, the license file may be limited to appending operations only.

In a number of embodiments, once transactions are generated, they are added to a general pool of transactions that have not yet been logged in a closed ledger block. This pool can vary in size and locality depending on the volume and locations of previous transactions and speed of closing blocks. The pool can simultaneously exist on several distributed notes that gather in coming transactions.

The block is closed (710), in many embodiments, by providing the solution to a block challenge by, e.g., finding a nonce that results in a block hash with a predetermined number of leading zero bits. Once solved, the solution is stored in the block itself. Closing a ledger block allows for the creation of a new block in the block chain, which also allows for a new creation right to be logged as well as pooled transactions to be recorded. In further embodiments, the closing of a block is done using a proof-of-work method. The proof of work helps to distribute the verification, relying in several embodiments on an assumption that no single entity can perform more than 50% of the work (e.g. owning more than 50% of the processing power applied to try to provide the proof and to be able to re-create a longer chain by itself). It also ensures that the verification cannot easily be done on a falsified transaction ledger, in particular as blocks age and are verified with each following proof of work. The closing transaction can also include a time stamp to establish a processing order and age of the block. The proof of work also serves to decentralize the creation of signing of blocks and to make them hard to alter, after the proof of work has been performed. Proof of work can be provided by presenting a solution to a challenge that is hard to find but easy to verify, such as finding content that results in a constrained hash code. In other embodiments, an alternative proof of stake is used, where the probability to get permission to sign a block is increased with the stake a participant has in the system. It is assigned randomly but likelihood is biased towards participants with a larger stake in the system. The stake in several embodiments of the invention is measured with the number of creations combined with the number of licensees, assuming that the creators have largest interest to maintain the stability of the system and large creators will continue to issue large number of works in particular if licensees are limited. Other measurements, such as those that include licensees, platforms and activities of licenses for creators, can also be contemplated.

In many embodiments, in order to close a ledger block, a block challenge must be solved by the ledger block closing application. In further embodiments the block challenge to be solved requires producing a hash output of the block that yields a certain type of value. In still further embodiments, the hash output required to solve a block challenge has a variable number of leading zero bits in the output value. This value can be generated by adding a nonce to the end of the block to close until the desired hash output is generated. In yet still further embodiments the block challenge requirements are stored in the block closing application. In certain embodiments the block challenge requirements may be adjusted in order to adapt to changing conditions in the decentralized ledger system. Techniques for blockchain management are described in “Bitcoin: A Peer-to-Peer Electronic Cash System” by Satoshi Nakamoto, published in 2008, the disclosure of which relevant to developing block challenges is hereby incorporated by reference in its entirety.

Once closed, the block may then be distributed (712) to other available and participating nodes in the decentralized ledger system. The closing of the block seals in the transactions and makes the ledger harder to modify. In particular also earlier transactions are secured as the content of this block includes a cryptographic link to previous blocks (704).

Although specific processes regarding creating new ledger blocks are described above with reference to FIG. 7, any of a variety of processes can be implemented using available nodes or playback devices as appropriate to the requirements of the specific applications in accordance with various embodiments of the invention. Once created, while open, ledger blocks may have transactions added. Playback of content using a blockchain rights ledger in accordance with embodiments of the invention is described below.

### Processes for Playback of Content Using a Blockchain Rights Ledger

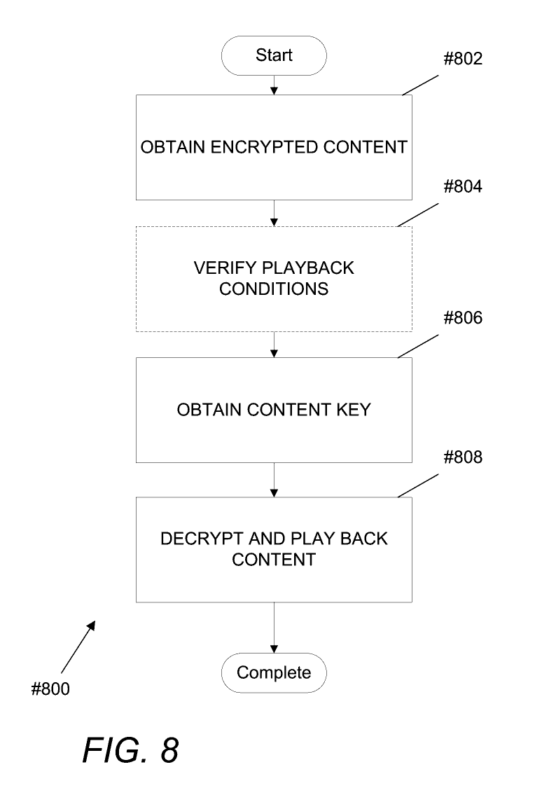

A playback device having access to a blockchain rights ledger can utilize transaction information in the ledger to enable playback of a piece of content. A process for playing back content in accordance with embodiments of the invention is illustrated in FIG. 8. The process 800 includes obtaining (802) encrypted content and accessing the blockchain rights ledger. The content may be obtained by any of a variety of methods, including but not limited to, downloading to a local copy, streaming over a network, and/or playing a stored local copy.

The process 800 can include verifying (804) playback conditions. Playback conditions can include the presence of security features such as, but not limited to, High-bandwidth Digital Content Protection (HDCP), types of output ports (HDMI, DVI, VGA, etc.), and/or software integrity. Additional conditions can include license duration (i.e., not expired) and checking play count and platform activation count.

The process 800 includes obtaining (806) a content decryption key. In some embodiments, the content decryption key is encrypted by a public key of a public and private key pair associated with the user requesting playback. In other embodiments, the content decryption key is encrypted by a public key of a public and private key pair associated with the platform that is playing back the content. In still further embodiments, part of the content key is encrypted by the user public key and part of the content key is encrypted by the platform public key. Obtaining the content decryption key involves decrypting the encrypted key (or key part) with the corresponding private key of the public and private key pair (and combining key parts if separated).

The process 800 includes decrypting (808) the encrypted content using the content key and playing back the decrypted content.

While a specific process for playing content using a blockchain rights ledger is described above with respect to FIG. 8, any of a variety of processes may be utilized in accordance with the invention. Finally, an examination of security concerns about the decentralized ledger system are addressed.

### Security Concerns

In many embodiments, a decentralized ledger system allows for the tracking of pirated content. The public registration of the license acquisition process and its use can enable the tracking of last use and correlate behavior with pirated content. In particular, cases where the number of licensees is small, like when only a single license exists, the holder at the time of the piracy occurrences can be observed. In many additional embodiments, digital watermarking that embeds a client identifier that is unique to the platform or playback device, timestamp, and/or information about the public-private key pair or certificate during license use can further help track content leaks. In still additional embodiments, the client identifier may be specific to the client and environment but may also be specific to an individual executable belonging to an individual person. The former allows for intelligence to improve platforms and secure them better. This also allows for revocation of individual platforms that may be compromised or detected as used for piracy.

In further embodiments, friction in license transfers is introduced. These frictions in license transfer may include, but are not limited to: transfer time limitations or limitations in transfer count numbers to mirror current use restriction of physical assets (such as wear of DVDs) and transfer times (mailing). In still further embodiments, license transfer friction also limits denial of service (DoS) attacks that create a large number of real transactions, usually in the form of repeat exchanges of licenses between a small number of entities within milliseconds, with the intent to create traffic that will disrupt operation of the system. In certain embodiments, transactions that come with an expense are given higher priority. In certain further embodiments, transactions without friction are allowed but limited by a maximum number per ledger block. Licensing from the owner to the licensee may be limited in the same fashion. To increase the amount of enabled licensees, one creation can be registered multiple times. The issuing of new works is difficult to abuse as a DoS attempt, as registration is already limited by the work necessary to solve a block challenge and close a ledger block.

In still further embodiments, the ledger that is designed to act as a rights locker for digital assets may also include relevant transactions with existing ledgers, including other currency block chains. The benefits of such a system are to enable an easier start and penetration of the system as the decentralized ledger can participate in an existing updated system that already has regular issuing of blocks and distributed consensus on a time stamping service. In yet still further embodiments, to include the decentralized rights ledger with another block chain, the transactions can be hashed and the hash included in the other ledger and documented fully elsewhere. This location can be found using the hash in a public database or specified separately using a URL (uniform resource locator) included in the transaction.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed is:

1. A playback device for accessing content using a decentralized blockchain rights ledger comprising:
a processor;
a network interface;
a memory connected to the processor, where the memory comprises:
a decentralized blockchain rights ledger;
a platform identifier;
a public and private key pair associated with the platform;
a ledger modification application; and
a playback application;
wherein the ledger modification application configures the processor to:
receive a first new block created and distributed by a first blockchain management device;
update the decentralized blockchain rights ledger with the first new block received from the first blockchain management device;
wherein the playback application directs the processor to:
obtain an encrypted digital media work;
generate a digital representation of the digital media work stored in memory;
locate a platform license transaction corresponding to the identified digital representation and matching platform identification number, where the platform activation transaction identifies a platform that is permitted to play back the digital media work and contains an encrypted content key with which the digital media work can be decrypted, where the encrypted content key is encrypted with a public key of a public and private key pair associated with the identified platform; and
decrypt the encrypted content key using the private key of the public and private key pair associated with the platform; and
decrypt content from the digital media work using the decrypted content key and play back the decrypted content.

2. The playback device of claim 1, wherein the playback application further directs the processor to:
generate a digital representation of the digital media work stored in memory;
locate a license issuance transaction corresponding to the identified digital representation and matching the digital signature associated with the user, where the license issuance transaction identifies a user that is permitted to play back the digital media work and contains an encrypted content key with which the digital media work can be decrypted, where the encrypted content key is encrypted with a user key associated with the identified user;
decrypt the encrypted content key using the private key of the public and private key pair associated with the user;
decrypt content from the digital media work using the decrypted content key and play back the decrypted content.

3. The playback device of claim 1, wherein the playback application further directs the processor to:
generate a digital representation of the digital media work stored in memory;
locate a platform license transaction corresponding to the identified digital representation and matching platform identification number, where the platform license transaction identifies a platform that is permitted to play back the digital media work and contains a first encrypted content key segment of a content key with which the digital media work can be decrypted, where the first encrypted content key segment is encrypted with a platform key associated with the identified platform;
locate a license issuance transaction corresponding to the identified digital representation and matching the digital signature associated with the user, where the license issuance transaction identifies a user that is permitted to play back the digital media work and contains a second encrypted content key segment of a content key with which the digital media work can be decrypted, where the second encrypted content key segment is encrypted with a user key associated with the identified user;
decrypt the first encrypted content key segment using the private key of the public and private key pair associated with the platform;
decrypt the second encrypted content key segment using the private key of the public and private key pair associated with the user; and
generate a combined content key based on the first and second encrypted content key segments;
decrypt content from the digital media work using the combined content key and play back the decrypted content.

4. The playback device of claim 1, further comprising a licensing terms verification application stored in memory that directs the processor to:
access the decentralized blockchain rights ledger stored in memory;
generate a digital representation of the digital media work stored in memory;
locate a license issuance transaction corresponding to the identified digital representation and matching a digital signature associated with the user;
determine the license restrictions contained in the license issuance transaction;
enforce the restrictions while playing back the digital media work.

5. The playback device of claim 1 wherein the license restrictions are selected from the group consisting of: playback counts, sublicensing authorization, duration use limits, and license transfer parameters.

6. The playback device of claim 1 further comprising a licensing terms verification application stored in memory that directs the processor to:
generate a digital representation of the digital media work stored in memory;
locate a license issuance transaction in the rights ledger corresponding to the generated digital representation;
determine the license issuance transaction identifier from the located license issuance transaction;
generate a play count transaction by logging a play count transaction type identifier, the license issuance transaction identifier, the platform identifier, and a digital signature generated using the private key of the public and private key pair associated with the platform; and
distribute the play count transaction to other devices participating in the decentralized rights management system.

7. The playback device of claim 1 further comprising a licensing terms verification application stored in memory that directs the processor to:
generate a digital representation of the digital media work stored in memory;
determine the number of play count transactions in the rights ledger corresponding to the identified digital representation, platform identification number, and digital signature corresponding to the platform;
compare the number of play count transaction to a predetermined play count limit number; and
configure playback conditions based on the comparison of play count transactions to the predetermined play count restriction number.

8. The playback device of claim 1 further comprising a licensing terms verification application stored in memory that directs the processor to:
generate a digital representation of the digital media work stored in memory;
determine a platform instance identifier;
generate a platform activation transaction by logging a platform activation transaction type identifier, the digital representation of the digital media work, and the platform instance identifier.

9. A method for maintaining a digital rights ledger comprising:
accessing a decentralized blockchain rights ledger;
generating a registration entry for addition to the decentralized blockchain rights ledger wherein the registration entry is generated by logging a digital representation of a digital media work and a public key associated with a creator of the digital media work;
determining whether any transactions not previously entered into the decentralized blockchain rights ledger are present in the memory;
generating a new header identification to represent a new block in the blockchain;
identifying a last closed block in the ledger;
locate header identification of the last closed block in the blockchain ledger;
generating a reference using the last closed block's header identification;
grouping the registration entry, unentered transactions when they are present, new header identification, and the reference to the last closed block into a single new block for addition to the blockchain system;
receiving a hash challenge utilized to close the new block;
creating a hash solution satisfying the hash; and
distributing the new block in the blockchain to a plurality of other nodes in the decentralized blockchain rights ledger management system.

10. A blockchain management device for maintaining a decentralized blockchain rights ledger comprising:
a processor;
a network interface; and
a memory connected to the processor, where the memory comprises:
a public and private key pair associated with a creator of a digital media work; and
a ledger creation application;
wherein the ledger creation application directs the processor to:
access a decentralized blockchain rights ledger stored in memory;
generate a registration entry for addition of a work to the blockchain rights ledger wherein the registration entry comprises a unique digital representation of a digital media work a public key to enable control over the work by using the corresponding private key and a proof of the right to register the work; and
distribute the transaction in the blockchain rights ledger to other blockchain management devices using the network interface.

11. The blockchain management device of claim 10 wherein the hash solution is generated by generating a hash of the new block including a nonce wherein the nonce is generated by attempting a series of hash solutions until a hash solution is found that satisfies the hash challenge.

12. The blockchain management device of claim 10 wherein generating a solution to a hash challenge is accomplished through a proof of stake system.

13. The blockchain management device of claim 10 wherein the memory further comprises a ledger modification application wherein the ledger modification application directs the processor to:
access the decentralized blockchain rights ledger stored in memory to register a new license to a digital media work that is represented by a registration entry in the blockchain system; and
generate a license issuance transaction by logging the digital registration of the digital media work along with the terms of the license, a transaction type identifier, the public key of the public and private key pair associated with the creator of the digital media work, and a public key of a public and private key pair associated with the licensee of the digital media work.

14. The blockchain management device of claim 13 wherein the ledger modification application further directs the processor to digitally sign the license issuance transaction with the private key of the public and private key pair associated with the licensor and with the private key of the public and private key pair associated with the licensee.

15. The blockchain management device of claim 13 wherein the ledger modification application further directs the processor to encrypt at least a portion of a content key using the public key of the public and private key pair associated with the licensee, where the content key can be used to decrypt an encrypted copy of the digital media work.

16. The blockchain management device of claim 13 wherein the terms of the license are selected from the group consisting of: playback counts, sublicensing authorization, duration use limits, expiration dates, and license transfer parameters.

17. The blockchain management device of claim 10 wherein the memory further comprises a ledger modification application wherein the ledger modification application directs the processor to:
access the decentralized blockchain rights ledger stored in memory to transfer an existing license, which is represented by a license issuance transaction, to a digital media work that is represented by a digital registration in the decentralized blockchain rights ledger;
generate a license transfer transaction by logging the digital registration of the digital media work to transfer along with a transaction type identifier, the public key of a public and private key pair associated with the licensor of the digital media work, and a public key of a public and private key pair associated with the licensee of the digital media work.

18. The blockchain management device of claim 10 wherein the memory further comprises a ledger modification application wherein the ledger modification application directs the processor to:
generate a platform license transaction that comprises a platform identifier, identification of a digital media work, and a signature generated using the private key of a public and private key pair associated with the creator of the digital media work.

19. The playback device of claim 1, wherein the ledger modification application further configures the processor to:
receive a second new block created and distributed by a second blockchain management device;
update the decentralized blockchain rights ledger with the second new block received from the second blockchain management device.
